(19) United States
(12) Patent Application Publication
(10) Pub. No.: US 2008/0011338 A1
(43) Pub. Date: Jan. 17, 2008

(54) No-spray-arm-rack-based pressure wash system for dishwashers

(76) Inventor: Yuyong Zhao, Hoffman Estates, IL (US)

Correspondence Address: Yuyong Zhao, 6068 Canterbury Ln, Hoffman Estates, IL, 60192, US

(21) Appl. No.: 11/457,806

(22) Filed: Jul. 16, 2006

(51) Int. Cl. B08B 3/00

(52) U.S. Cl. 134/198

(57) ABSTRACT

A dish rack consists of horizontal and vertical water conduits, with a plurality of vertical water conduits connected to each horizontal water conduit. Each vertical water conduit has a number of upward angled water nozzles. A water supply switch box is connected to said dish rack. Said switch box is connected to a water pump through an extendible hose. Said switch box directs pressured water to two said horizontal water conduits on said dish rack at a time. Pressured water is then forced out through nozzles on said vertical water conduits. Kitchen ware is washed directly by pressured water.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention pertains to the arts of dishwashers and, more specifically, to a wash and rinse mechanism employed in a dishwasher.

2. Discussion of the Prior Art

The typical residential dishwashers consist of two dish racks, and at least one spray arm with multiple nozzles to direct fluids towards the ware in the washing chamber. Due to various shapes of the ware to be washed, and the proximity of the ware to be washed, the fluid jets are oftentimes blocked so not to be able to reach the soiled ware. For instance, a plate in front of another plate often blocks the fluid jets from reaching the second plate; the wall of a cup often blocks the fluid jets from reaching the interior of the cup. Only a fraction of the ware surface is reached directly with pressured fluids. Much of the ware surface is washed only with dripping fluids with no pressure. As a consequence, it takes a long time to finish a wash cycle. Oftentimes, the ware is still not completely cleaned after a long wash cycle. A side problem of the current spray system is the high noise because the fluid jets have to travel a long distance and often reach the washing chamber walls. Overall, the current system is inefficient and ineffective.

A need exists so that the fluid jets can reach the ware directly and with pressure.

### BRIEF SUMMARY OF THE INVENTION

The present invention overcomes the inefficiency and ineffectiveness of the current washing mechanism. Instead of the spray arm, the present invention relies on the dish rack itself to carry and direct the fluids under pressure towards the ware to be washed. The dish rack consists of a number of horizontal water conduits. In a preferred embodiment of the present invention, each horizontal water conduit on said dish rack is blocked in the middle to form two separate halves, in order to reduce the travel distance of water and maximize water pressure. Each horizontal water conduit has a number of vertical water conduits mounted on and connected to it. Each vertical water conduit has a number of nozzles spread around it and directed at various upward angles.

A water supply switch box is attached to said dish rack. According to one embodiment of the present invention, each half of said horizontal water conduit on said dish rack is connected and sealed to one water supply outlet on said switch box. The water supply outlets of said switch box are spread evenly on a circle on a first plate. A second rotating and geared plate is pressed against the first plate. There exists an opening on the second plate that covers two water supply outlets on the first plate. When the second plate rotates, water is directed to two water outlets on the first plate at a time. Said water supply switch box has a source water inlet connected to a water pump. A turbine is mounted at the side of the source water inlet and extends to up to half of the inlet opening to minimize resistance to water flow and maximize force gained from the water flow. The turbine has a geared axle which is perpendicular and engaged to said second geared plate. When pressured water from the pump enters the switch box, the turbine is caused to rotate, which in turn causes said second plate to rotate and direct water to two water outlets on said first plate at a time.

In an alternative embodiment of the present invention, a mechanical or electronic timer controls the opening and closing of the water supply switch.

Accordingly, an object of the present invention is to enable the washing fluids to reach the ware directly and with pressure; to accomplish said object without major changes to the current washing platform; to provide consumers a dishwashing experience that is more efficient, more effective and quieter.

### BRIEF DESCRIPTION OF THE DRAWINGS

FIG. 1 is a top view of the dish rack;

FIG. 2 is a sectional view of the vertical water conduits showing nozzles directed upward at various degrees;

FIG. 3 is a bottom view of the dish rack and the first water supply switch plate of the water supply switch box, showing each half of a horizontal water conduit connected to one water supply outlet;

FIG. 4 is a bottom view of the second water supply switch plate and the gear axle of the turbine.

FIG. 5 is a perspective view of the water intake opening on the water supply switch box, the turbine with geared axle and the second water supply switch plate;

### DETAILED DESCRIPTION OF PREFERRED EMBODIMENTS

Referring to the drawings, FIG. 1 shows a dish rack with the conventional structure but with horizontal and vertical water conduits. The solid grid lines help reinforce the structure and hold the kitchen ware. The horizontal and vertical water conduits transport and direct water towards the kitchen ware through nozzles on the vertical conduits.

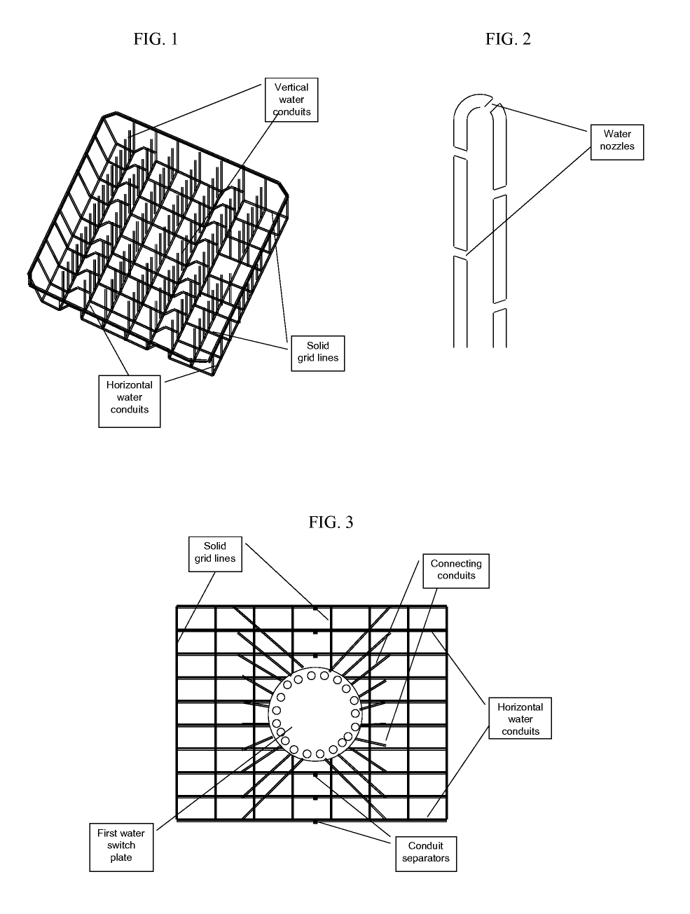

FIG. 2 shows the vertical water conduits with nozzles spread around and directed upwards at various degrees. The water nozzles are randomly distributed so adjacent vertical water conduits together can cover as much surface of an item to be washed as possible. It's important to have the top nozzle to prevent buildup of food scraps in the conduit.

FIG. 3 shows the bottom of the dish rack connected to the first plate of the water supply switch box. Please note that each horizontal water conduit is blocked in the middle to form two separate halves, in order to reduce travel distance of water flow and maximize water pressure. Each half of the horizontal conduit is connected to one water outlet on the first water switch plate.

FIG. 4 shows the geared second water supply switch plate engaged with the geared turbine axle. The water supply outlets on the first switch plate are represented by dotted circles. When the turbine turns, the turbine axle causes the second plate to rotate. There is an opening on the second plate that covers two water outlets on the first plate. The size of the opening makes sure that there is at any time at least one water outlet on the first plate open to enable water flow.

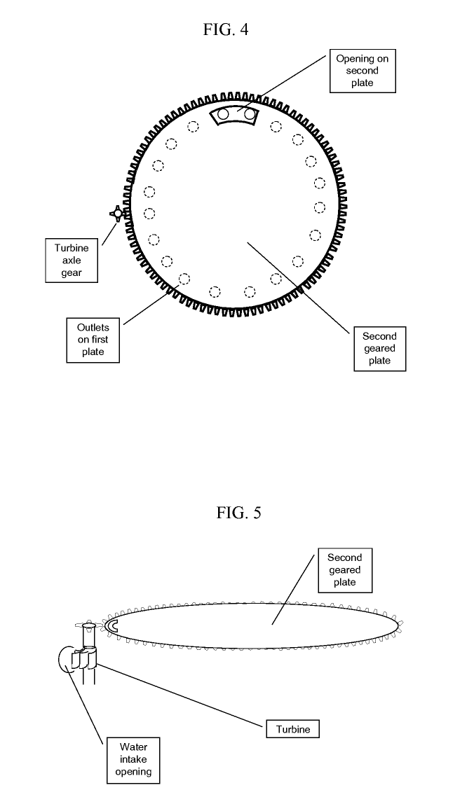

FIG. 5 is a perspective view of the water intake opening, the turbine and the second water switch plate. The water intake opening is connected to the water pump through an extendible hose. When pressured water enters the switch box from the pump, the turbine is caused to turn, which in turn causes the second water switch plate to rotate. When the second plate rotates, the opening on the second plate is moved to the next water outlets on the first plate and directs water to two outlets at a time.

While the forms of apparatus disclosed herein constitute preferred embodiments of the present invention, those knowledgeable in the art understand that the invention is not limited to these precise forms of apparatus, and that changes may be made therein without departing from the scope of the invention as defined by the appended claims.

1. A dish rack made of horizontal and vertical water conduits, comprising:
Horizontal and vertical water conduits;
Angled nozzles at various degrees on said vertical conduits to direct pressured water towards ware to be washed.

2. A water supply switch box, comprising:
a turbine with geared axle, placed at the water intake opening of said water switch box;
a first water switch plate with outlets spread on a circle and connected to horizontal water conduits on said dish rack;
a second rotating water switch plate, engaged to said turbine gear axle, and with an opening that covers two outlets on said first water switch plate;
